(19) United States
(12) Patent Application Publication
(10) Pub. No.: US 2014/0022818 A1
(43) Pub. Date: Jan. 23, 2014

(54) OPTICAL ELEMENT, ILLUMINATION DEVICE, AND PROJECTION DISPLAY DEVICE

(71) Applicants: Masanao Natsumeda, Tokyo (JP); Masao Imai, Tokyo (JP); Naofumi Suzuki, Tokyo (JP); Mizuho Tomiyama, Tokyo (JP); Shin Tominaga, Tokyo (JP); Yuji Ohno, Tokyo (JP)

(72) Inventors: Masanao Natsumeda, Tokyo (JP); Masao Imai, Tokyo (JP); Naofumi Suzuki, Tokyo (JP); Mizuho Tomiyama, Tokyo (JP); Shin Tominaga, Tokyo (JP); Yuji Ohno, Tokyo (JP)

(73) Assignee: NEC CORPORATION, Tokyo (JP)

(21) Appl. No.: 14/110,296

(22) PCT Filed: Mar. 15, 2012
(86) PCT No.: PCT/JP2012/056730

§ 371 Date: Oct. 7, 2013

(30) Foreign Application Priority Data
Apr. 7, 2011 (JP) 2011-085370
Jan. 6, 2012 (JP) 2012-001321

(51) Int. Cl. F21V 8/00

(52) U.S. Cl. CPC G02B 6/0016
USPC 362/607

(57) ABSTRACT

An optical element that is capable of reventing an increase in size while increasing the light intensity of fluorescent light includes: a light-guide plate (21) that propagates light incident from a light source (1); a phosphor layer (22) that is provided on the light-guide plate (21) and that generates fluorescent light by means of light from the light-guide plate (21); a metal layer (23) that is layered on the phosphor layer (22); and a diffraction grating that is formed at the interface of the phosphor layer (22) and the metal layer (23).

### TECHNICAL FIELD

The present invention relates to an optical element, an illumination device, and a projection display device.

### BACKGROUND ART

In recent years, projectors that use LEDs (Light-Emitting Diodes) as a light source are receiving increasing attention. This type of projector is provided with an LED, illumination optics into which light from the LED is irradiated, a modulating element that modulates light from the illumination optics in accordance with picture signals and emits the result, and projection optics that project light from the modulating element onto a screen.

As one type of illumination optics, the emitted light of the LED is irradiated upon a phosphor and the fluorescent light that is emitted by the phosphor is made incident to a modulating element. In a projector that employs this type of illumination optics, the light intensity of the fluorescent light is preferably raised to increase the luminance of the projected image.

The optical element disclosed in Non-Patent Document 1 is disclosed as a technology for raising the light intensity of fluorescent light. In this optical element, a metallic thin-film and a dielectric layer having a grating structure are successively layered on a substrate. In addition, quantum dots that function as a phosphor are applied to the dielectric layer.

When light is irradiated upon the quantum dots, excitons in the quantum dots are excited by the incident light. A portion of the excitons radiate fluorescent light, and the remaining excitons are consumed in the excitation of surface plasmons or the generation of electron-hole pairs and vanish without emitting fluorescent light. When the dielectric layer has a grating structure as described above, surface plasmons that are excited at the interface of the metallic thin-film and dielectric layer are diffracted and can be extracted as the same light as the fluorescent light.

Accordingly, in the optical element described in Non-Patent Document 1, the light intensity of fluorescent light can be augmented because the photons that are extracted by the diffraction of surface plasmons are added to the photons that are extracted when there is no grating construction. As a result, applying the optical element described in Non-Patent Document 1 to a fluorescent illumination device that performs illumination by fluorescent light enables an improvement of the luminance of the fluorescent light illumination device.

### LITERATURE OF THE PRIOR ART

### Non-Patent Documents

Non-Patent Document 1: Ehren Hwang, Igor I. Smolyaninov, Christopher C. Davis, NANO LETTERS, 2010, 10 pp. 813-820.

### SUMMARY OF THE INVENTION

### Problem to be Solved by the Invention

When the optical element described in Non-Patent Document 1 is used in the illumination optics of a projector, not only the optical element but also optics such as a condensing lens become necessary for irradiating light from the LED into the optical element or for irradiating the fluorescent light that is generated in the optical element into the modulating element, thereby giving rise to the problem in which the size of the projector increases.

It is therefore an object of the present invention to provide an optical element that can prevent an increase in the size while raising the light intensity of fluorescent light.

### Means for Solving the Problem

The optical element according to the present invention includes a light-guide plate that propagates light that is incident from a light source, a phosphor layer that is provided on the light-guide plate and that generates fluorescent light by the light from the light-guide plate, and a metal layer that is layered on the phosphor layer, wherein a diffraction grating is formed on the interface of the light-guide plate and the phosphor layer.

The illumination device of the present invention includes the above-described optical element and a light source that irradiates light into the light-guide plate of the optical element.

In addition, the projection display device of the present invention includes the above-described illumination device.

### EFFECT OF THE INVENTION

The present invention enables that the size of the projector will not become larger while increasing the light intensity of fluorescent light.

### BRIEF DESCRIPTION OF THE DRAWINGS

FIG. 1 is a perspective view that gives a schematic representation of the illumination device of the first exemplary embodiment of the present invention.

FIG. 2 is a vertical sectional view that gives a schematic representation of the illumination device of the first exemplary embodiment of the present invention.

FIG. 3 shows the relation between the coupling efficiency of excitons and surface plasmons, the interactive distance from excitons to the metal layer, and the dielectric constant of the light-guide plate.

FIG. 4 is a perspective view giving a schematic representation of the illumination device of the second exemplary embodiment of the present invention.

FIG. 5 is a vertical sectional view giving a schematic representation of the illumination device of the second exemplary embodiment of the present invention.

FIG. 6 is a perspective view giving a schematic representation of the third exemplary embodiment of the present invention.

FIG. 7 shows the configuration of a projector that uses the illumination device.

### BEST MODE FOR CARRYING OUT THE INVENTION

Exemplary embodiments of the present invention are next described with reference to the accompanying drawings. In the following explanation, elements having the same functions are given the same reference numbers and redundant explanation of these elements may be omitted.

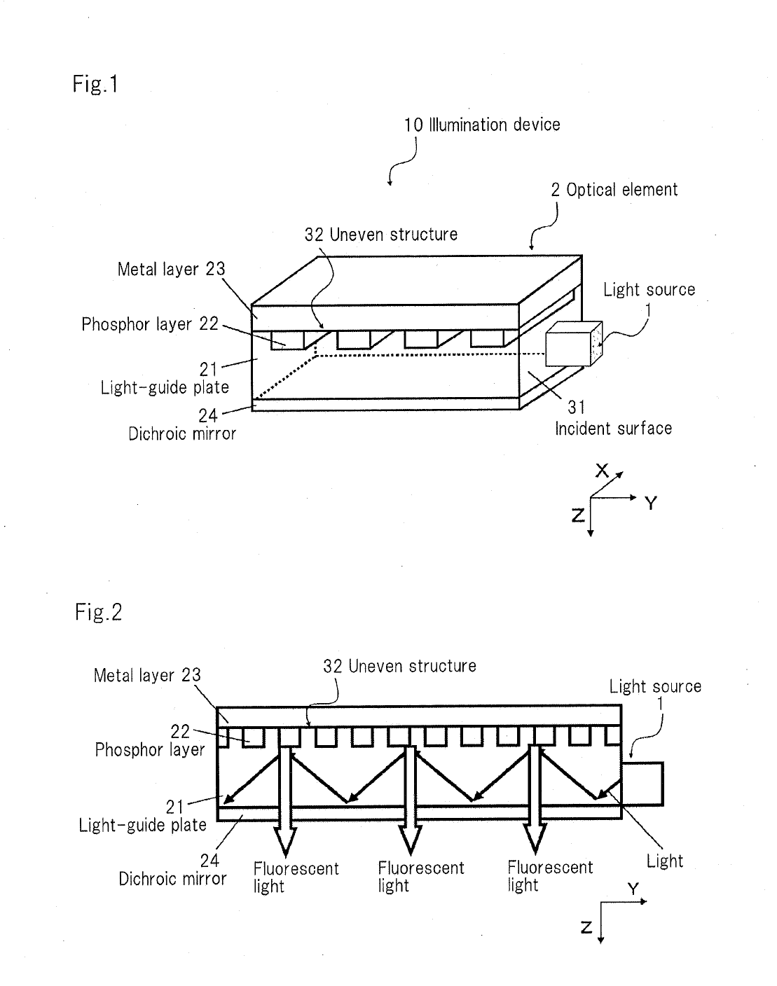

FIG. 1 is a perspective view that gives a schematic representation of the illumination device of the first exemplary embodiment of the present invention. In the actual illumination device, each layer is extremely thin and the differences in thicknesses of each layer are great, and therefore it is problematic to accurately represent the scale and proportion of each layer. As a result, each layer in the figures is represented schematically and is not depicted according to actual proportions.

Illumination device 10 shown in FIG. 1 includes light source 1 that emits light and optical element 2 into which light emitted from light source 1 is irradiated.

Light source 1 is, for example, an LED and is arranged on the outer periphery of optical element 2. In FIG. 1, light source 1 is arranged in contact with optical element 2, but light source 1 may also be arranged at a position that is separated from optical element 2, or may be optically connected with optical element 2 by way of a light guide part such as a light pipe.

Optical element 2 includes light-guide plate 21, phosphor layer 22, metal layer 23, and dichroic mirror 24.

Light-guide plate 21 is irradiated by light emitted from light source 1, and this incident light is propagated through the interior of light-guide plate 21. In the present exemplary embodiment, light-guide plate 21 is formed as a flat plate, and light source 1 is provided such that light source 1 is in contact with the side surface. The side surface that contacts light source 1 is incident surface 31. The shape of light-guide plate 21 is not limited to a flat plate. In addition, the upper surface of light-guide plate 21 is assumed to be the XY plane, and the direction orthogonal to the XY plane is assumed to be the Z direction.

Phosphor layer 22 is provided on the upper surface of light-guide plate 21. In addition, uneven structure 32 that functions as a diffraction grating is provided on light-guide plate 21 at the interface with phosphor layer 22. In the present exemplary embodiment, the unevenness of uneven structure 32 is arranged in a one-dimensional lattice form, but may be of another arrangement such as a triangular lattice form.

Phosphor layer 22 is arranged on the upper surface of light-guide plate 21. Phosphor layer 22 is a carrier-generating layer that absorbs incident light that is irradiated from light-guide plate 21 to generate excitons (carriers) and generates fluorescent light by means of these excitons. The material of phosphor layer 22 is preferably a nano-inorganic phosphor such as a quantum dot phosphor, but may also be an inorganic phosphor such as Eu, BaMgAlxOy:Eu or BaMgAlxOy:Mn, or an organic phosphor.

Uneven structure 32 that functions as a diffraction grating is formed on light-guide plate 21 at the interface with phosphor layer 22. In the present exemplary embodiment, the unevenness of uneven structure 32 is arranged in a one-dimensional lattice. However, the unevenness of the uneven structure may also be arranged in a triangular lattice form.

Metal layer 23 is layered on phosphor layer 22. The material of metal layer 23 is, for example, gold, silver, copper, platinum, palladium, rhodium, osmium, ruthenium, iridium, iron, tin, zinc, cobalt, nickel, chromium, titanium, tantalum, tungsten, indium, aluminum, or an alloy of these metals. The thickness of metal layer 23 is preferably formed no greater than 200 nm and is more preferably formed at 10 nm-100 nm.

Dichroic mirror 24 is a wavelength-selective component that is provided on the surface of light-guide plate 21 that is opposite the surface on which phosphor layer 22 is formed. Dichroic mirror 24 reflects light that is emitted from light source 1, transmits fluorescent light that is generated by phosphor layer 22, and emits only fluorescent light from optical element 2.

FIG. 2 is a view for describing the behavior of light in illumination device 10 and shows a vertical section taken along an YZ plane of illumination device 10 shown in FIG. 1.

As shown in FIG. 2, when light is emitted from light source 1, this light is irradiated into incident surface 31 of light-guide plate 21. The light that is irradiated into incident surface 31 is reflected by dichroic mirror 24 and irradiated into phosphor layer 22. In addition, a configuration may be adopted in which light that is irradiated into incident surface 31 is irradiated directly into phosphor layer 22.

A portion of the light that is incident to phosphor layer 22 is reflected by phosphor layer 22 and returned to light-guide plate 21. The light that is returned to light-guide plate 21 is again reflected by dichroic mirror 24 and irradiated into phosphor layer 22.

The remaining light that is irradiated into phosphor layer 22 is absorbed by phosphor layer 22 and causes excitation of excitons inside phosphor layer 22. A portion of the excitons are converted to fluorescent light by relaxating these excitons on and are emitted from optical element 2. A portion of the remaining excitons cause excitation of surface plasmons of the interface of metal layer 23 and phosphor layer 22. The excited surface plasmons are diffracted by uneven structure 32 and emitted from optical element 2.

In order to bring about excitation of the above-described surface plasmons, the wave number kₛₚₚ of the X and Y components of the wave number of the surface plasmons and the period k_{g} of the diffraction grating must coincide. In other words, if m is a positive integer, kₛₚₚ=m·K_{g} must be satisfied.

Wave number kₛₚₚ is determined according to the dielectric constant distribution of the incident/emission portions of optical element 2. The incident/emission portion is the dielectric constant distribution of the medium that is closer to the light-guide plate 21-side than metal layer 23 (in FIG. 1, light-guide plate 21 and phosphor layer 22).

If the real part of the dielectric constant of metal layer 23 is εₘₑₜₐₗ and the wave number of light in a vacuum is k₀, the wave number kₛₚₚ of the X component and Y component of the wave number of the surface plasmons and the Z component k_{spp,Z} of the wave number of surface plasmons is represented by:

$$\begin{matrix}Formulas 1 & \\ {k}_{spp , z} = \sqrt{{ɛ}_{eff} {k}_{0}^{2} - {k}_{spp}^{2}} & Equation ( 1 ) \\ {k}_{spp} = {k}_{0} Re [ \sqrt{\frac{{ɛ}_{eff} {ɛ}_{metal}}{{ɛ}_{eff} + {ɛ}_{metal}}} ] & Equation ( 2 )\end{matrix}$$

ε_{eff} is the effective dielectric constant of the incident/emission portions. If the angular frequency of fluorescent light emitted from phosphor layer 22 is co, the dielectric constant distribution of incident/emission portions is ε(ω, x, y, z), and the imaginary number unit is j, the effective dielectric constant ε_{eff} is determined based on the dielectric constant distribution of incident/emitted portions and the distribution of surface plasmons with respect to the direction that is perpendicular to the interface of the light-guide body 21-side of metal layer 23, and is represented by:

$$\begin{matrix}Formula 2 & \\ {ɛ}_{eff} = {( \frac{{\int \int \int }_{D} Re [ \sqrt{ɛ ( ω , x , y , z )} ] exp ( 2 j {k}_{spp , z} z )}{{\int \int \int }_{D} exp ( 2 j {k}_{spp , z} z )} )}^{2} & Equation ( 3 )\end{matrix}$$

Here, Re[ ] represents the real part in the brackets [ ].

The integral range D in Equation (3) is the three-dimensional range on the light-guide plate 21-side of metal layer 23. More specifically, the range of the XY plane of integral range D is a range within metal layer 23, and the range in the Z-direction of the integral range is the range from the interface of metal layer 23 and phosphor layer 22 to infinity on the side of light-guide plate 21. The interface of metal layer 23 and phosphor layer 22 is Z=0, and the direction of increasing distance from this interface toward light-guide plate 21 is the +Z direction.

The effective dielectric constant ε_{eff} may also be calculated using the following equation. However, the use of Equation (3) is preferable.

$$\begin{matrix}Formula 3 & \\ {ɛ}_{eff} = \frac{{\int \int \int }_{D} Re [ ɛ ( ω , x , y , z ) ] exp ( 2 j {k}_{spp , z} z )}{{\int \int \int }_{D} exp ( 2 j {k}_{spp , z} z )} & Equation ( 3.1 )\end{matrix}$$

Wave number kₛₚₚ can be found from the dielectric constant distribution ε(ω, x, y, z) of the incident/emission portions by using Equation (1), Equation (2), and Equation (3). More specifically, the dielectric constant distribution ε(ω, x, y, z) of the incident/emission portions is substituted in Equation (3), an initial value that is appropriate to the effective dielectric constant ε_{eff} is given, the actual effective dielectric constant ε_{eff} is calculated by repeatedly calculating the wave numbers kₛₚₚ and k_{spp,Z} of surface plasmons and the effective dielectric constant ε_{eff} using Equation (1), Equation (2), and Equation (3), and the wave number kₛₚₚ can then be found from this actual effective dielectric constant ε_{eff}.

Accordingly, if Equation (1), Equation (2), and Equation (3) are used to adjust the period of the diffraction grating and the dielectric constant distribution of the incident/emission portions to satisfy kₛₚₚ=m·Kg, the excited surface plasmons can be efficiently extracted and the effect of augmenting fluorescent light can be increased.

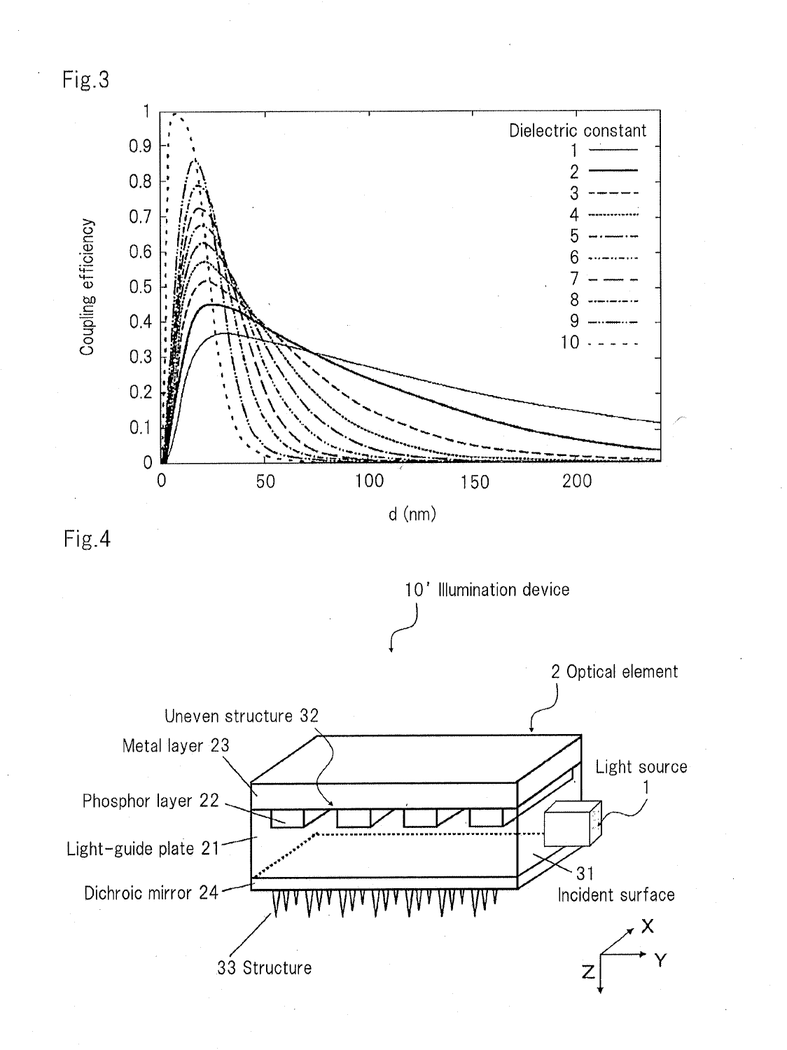

FIG. 3 shows the relation between the coupling efficiency of excitons and surface plasmons, the interactive distance from excitons to metal layer 23, and the dielectric constant of light-guide plate 21. The coupling efficiency of excitons and surface plasmons indicates the proportion, among excited excitons, of excitons that cause excitation of surface plasmons.

As shown in FIG. 3, the greater the interactive distance, which is the distance from excitons to metal layer 23, the smaller the coupling efficiency of excitons and surface plasmons. In order to raise the intensity of surface plasmons, the interactive distance should be adjusted such that the coupling efficiency of excitons and surface plasmons increases. For example, the distance from the surface of phosphor layer 22 that is opposite metal layer 23 to metal layer 23 should be set to the order of the effective interactive distance, which is the interactive distance at which the intensity of surface plasmons reaches e⁻² times the maximum value. The effective interactive distance d_{eff} is represented by:

$$\begin{matrix}Formula 4 & \\ {d}_{eff} = Im [ \frac{1}{{k}_{spp , z}} ] & Equation ( 4 )\end{matrix}$$

Because the effective interactive distance in an actual optical element is in the order of several hundred nanometers, in order to increase the fluorescent light and coupling efficiency of surface plasmons, the particle radius of phosphor material that is the material of phosphor layer 22 is preferably on the nanometer order.

In addition, as shown in FIG. 3, the maximum value of the coupling efficiency of excitons and surface plasmons increases as the dielectric constant of light-guide plate 21 increases. The dielectric constant of light-guide plate 21 is preferably as high as possible. However, the real part of the effective dielectric constant of the incident/emission portions must be set so as not to greatly exceed the absolute value of the real part of the dielectric constant of metal layer 23. If the real part of the effective dielectric constant of the incident/emission portions exceeds the absolute value of the real part of the dielectric constant of metal layer 23, a state results in which surface plasmons do not undergo excitation, as indicated by Equation (2). In actuality, the dielectric constant of metal layer 12 has an imaginary part, and surface plasmons are therefore excited even if the real part of the effective dielectric constant of the incident/emission portions exceeds the absolute value of the real part of the dielectric constant of metal layer 23, but the surface plasmons are not excited if there is great separation between the real part of the effective dielectric constant of the incident/emission portions and the absolute value of the real part of the dielectric constant of metal layer 23.

In the present exemplary embodiment as described hereinabove, optical element 2 includes phosphor layer 22 that is provided on light-guide plate 21 and metal layer 23 that is layered on phosphor layer 22, and a diffraction grating is formed on the interface of light-guide plate 21 and phosphor layer 22. Surface plasmons are excited on the interface of phosphor layer 22 and metal layer 23 by the excitons in phosphor layer 22, and these surface plasmons can also be extracted as fluorescent light, whereby the light intensity of the fluorescent light can be increased. In addition, because fluorescent light that is emitted from light-guide plate 21 can be irradiated into a display element, optical element 2 can be used as the illumination optics of a projector, and because optical element 2 and the illumination optics can be of a unified form, an increase in the size of the optical element can be prevented.

In addition, because the light intensity of the fluorescent light can be increased, the size of the emission surface of optical element 2 can be made relatively small.

Still further, fabrication of optical element 2 can be simplified in the present exemplary embodiment because a diffraction grating can be created on the interface of light-guide plate 21 and phosphor layer 22 by merely providing uneven structure 32 on light-guide plate 21. In addition, the fabrication of optical element 2 can be further simplified because phosphor layer 22 can be fabricated by a screen-printing process.

Another exemplary embodiment of the present invention is next described.

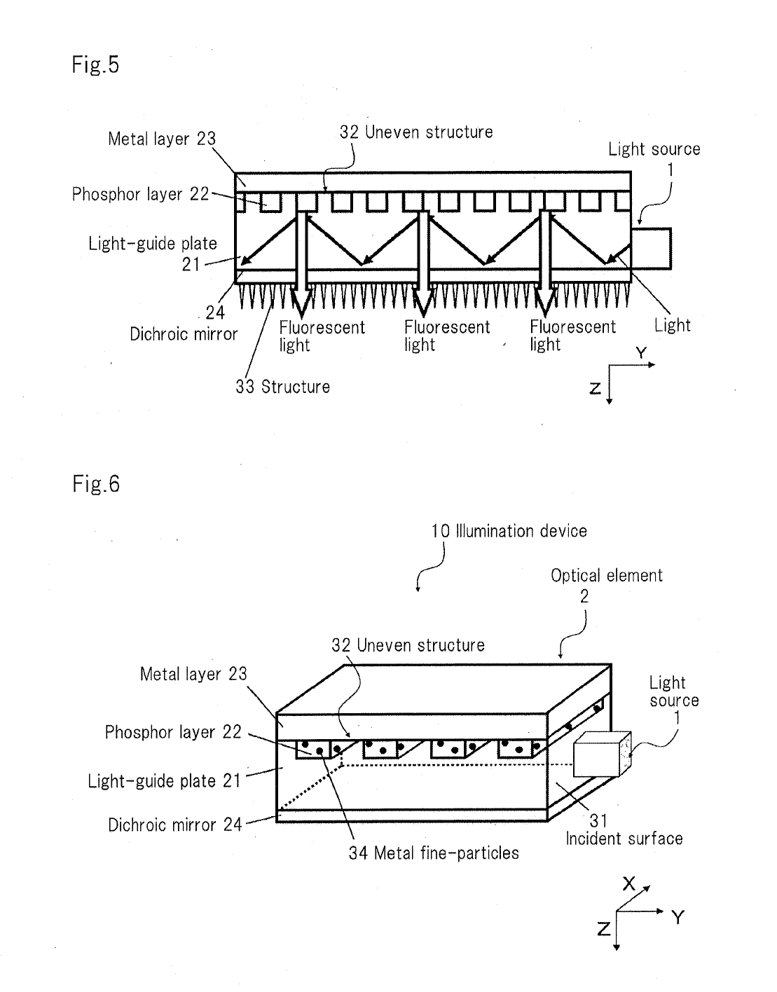

FIG. 4 is a perspective view that gives a schematic representation of the illumination device of the second exemplary embodiment of the present invention. In addition, FIG. 5 is a view for describing the behavior of light in the illumination device of the second exemplary embodiment of the present invention, and shows a section taken at a YZ plane of the illumination device shown in FIG. 4.

Illumination device 10′ shown in FIG. 4 and FIG. 5 further includes structure 33 in addition to the configuration shown in FIG. 1.

Structure 33 is provided on the surface of dichroic mirror 24 that is opposite the surface on which light-guide plate 21 is provided. Structure 33 reduces reflection of fluorescent light that is emitted from phosphor layer 22 to improve the transmittance of fluorescent light in dichroic mirror 24. A photonic crystal, a moth-eye structure, or a lens array can be used as structure 33.

According to the present exemplary embodiment, the transmittance of fluorescent light is improved by means of structure 33, whereby the luminance of fluorescent light emitted from illumination device 10′ can be improved.

FIG. 6 is a perspective view showing the illumination device of the third exemplary embodiment of the present invention. Illumination device 10″ shown in FIG. 6 differs from illumination device 10 shown in FIG. 1 in that phosphor layer 22 includes metal fine-particles 34.

Metal fine-particles 34 increase the apparent absorbance of incident light that is irradiated into phosphor layer 22. The apparent absorbance is the absorbance when phosphor layer 22 is considered a homogeneous layer and light is irradiated over the entire surface of phosphor layer 22. By interacting with the incident light, metal fine-particles 34 cause excitation of surface plasmons on the surface of metal fine-particles 34, giving rise to an enhanced electric field of a magnitude that approaches 100 times that of the electric field intensity of incident light in the vicinity of the surface. This enhanced electric field generates excitons in phosphor layer 22 and therefore increases the number of excitons in phosphor layer 22. As a result, metal fine-particles 34 can, by means of the surface plasmons that are excited in its own surface, increase the apparent absorbance of incident light and thus increase the light intensity of fluorescent light.

Materials that can be used as the material of metal fine-particles include: gold, silver, copper, platinum, palladium, rhodium, osmium, ruthenium, iridium, iron, tin, zinc, cobalt, nickel, chromium, titanium, tantalum, tungsten, indium, and aluminum, or an alloy of these metals. Of these, gold, silver, copper, platinum, and aluminum or an alloy that takes these metals as principal components is preferable, and gold, silver and aluminum or an alloy that takes these metals as principal components is particularly preferable. Metal fine-particles 34 may be a core-shell structure in which metal types differ for the periphery and the core, a combined hemispherical structure in which hemispheres of two types are combined, or a cluster-in-cluster structure in which different clusters are aggregated to produce fine particles.

Making metal fine-particles 34 an alloy or these special structures enables control of the resonant wavelength without varying the dimensions or shapes of the fine particles.

The shape of metal fine-particles 34 may be any shape having a closed surface, such as a rectangular parallelepiped, a regular hexahedron, an ellipsoid, a sphere, a triangular pyramid, or a triangular prism. In addition, metal fine-particles 34 include forms in which metal thin-film is processed by micro-fabrication, of which a semiconductor lithography is representative, to include a structure composed of closed surfaces having one side less than 10 μm.

According to the present exemplary embodiment, the light intensity of fluorescent light can be increased by means of metal fine-particles 34 in phosphor layer 22, whereby luminance can be improved.

A projector (projection image display device) that uses the illumination device is next described.

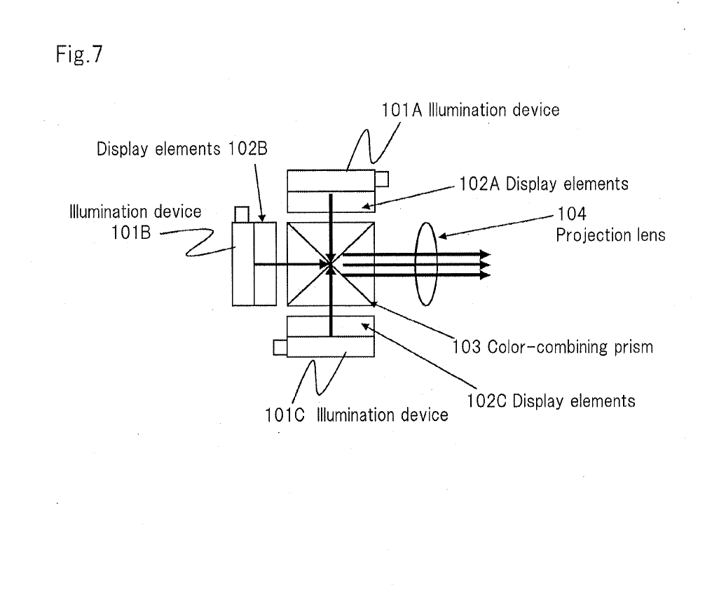

FIG. 7 shows the configuration of a projector that uses the illumination devices. The projector shown in FIG. 7 includes illumination devices 101A-101C, display elements 102A-102C, color-combining prism 103, and projection lens 104.

Illumination devices 101A-101C are made up by illumination device 10 shown in FIG. 1, illumination device 10′ shown in FIG. 2, or illumination device 10″ shown in FIG. 6. Phosphor layers 22 in each of illumination devices 101A-101C produce fluorescent light of respectively different colors. For example, phosphor layers 22 in each of illumination devices 101A-101C produce fluorescent light of red, green, and blue, respectively.

Display elements 102A-102C modulate the fluorescent light from each of illumination devices 101A-101C, respectively, in accordance with image signals and emit the result to color-combining prism 103. In FIG. 6, display elements 102A-102C are each arranged to contact dichroic mirrors 24 of each of illumination devices 101A-101C, respectively, but may also be arranged at positions separated from dichroic mirrors 24.

Color-combining prism 103 combines the fluorescent light from each of display elements 102A-102C and emits the resulting light by way of projection lens 104.

The configurations shown in the figures in each of the above-described exemplary embodiments are merely examples, and the present invention is not limited to these configurations.

This application claims the benefits of priority based on Japanese Patent Application No. 2011-085370 for which application was submitted on Apr. 7, 2011 and Japanese Patent Application No. 2012-001321 for which application was submitted on Jan. 6, 2012 and incorporates by citation all of the disclosures of these applications.

### EXPLANATION OF REFERENCE NUMBERS

1 light source
2 optical element
10, 10′, 10″, 101A-101C illumination device
21 light guide plate
22 phosphor layer
23 metal layer
24 dichroic mirror
31 incident surface
32 uneven structure
33 structure
34 fine particles
102A-102C display elements
103 color-combining prism
104 projection lens

1. An optical element comprising:
a light-guide plate that propagates light that is incident from a light source;
a phosphor layer that is provided on said light-guide plate and that generates fluorescent light by means of the light from said light-guide plate; and
a metal layer that is layered on said phosphor layer;
wherein a diffraction grating is formed on the interface of said light-guide plate and said phosphor layer.

2. The optical element as set forth in claim 1, further comprising a wavelength-selective part that is provided on the surface of said light-guide plate that is opposite the surface on which said phosphor layer is provided, that reflects light that is incident from said light source, and that transmits and emits fluorescent light generated from said phosphor layer.

3. The optical element as set forth in claim 2, further comprising a structure that is provided on said wavelength-selective part and that suppresses reflection of said fluorescent light.

4. The optical element as set forth in claim 13, wherein said diffraction grating is an uneven structure formed on said light-guide plate.

5. The optical element as set forth in claim 1, wherein said phosphor layer includes metal fine-particles in which surface plasmons are excited by light from said light-guide plate.

6. The optical element as set forth in claim 1, wherein the effective dielectric constant on the light guide body-side of said metal layer is at the upper limit of a range wherein the real part of the effective dielectric constant of the medium that is closer to said light-guide body-side than said metal layer does not surpass the absolute value of the real part of the dielectric constant of said metal layer.

7. The optical element as set forth in claim 6, wherein said effective dielectric constant is determined based on:
the dielectric constant distribution of the dielectric of the medium that is closer to said light-guide body-side than said metal layer; and
the distribution of surface plasmons with respect to the direction perpendicular to the interface of said metal layer in the medium that is closer to said light-guide body-side than said metal layer.

8. An illumination device comprising:
the optical element as set forth in claim 1; and
a light source that irradiates light to the light-guide plate of said optical element.

9. A projection image display device comprising the illumination device as set forth in claim 8.
